(19) United States
(12) Patent Application Publication
(10) Pub. No.: US 2015/0284268 A1
(43) Pub. Date: Oct. 8, 2015

(54) Method for Treating a Liquid

(71) Applicant: Klaus BÜTTNER, Klein Nordende (DE)

(72) Inventor: Klaus Buttner, Klein Nordende (DE)

(21) Appl. No.: 14/432,131

(22) PCT Filed: Sep. 18, 2013
(86) PCT No.: PCT/DE2013/100334

§ 371 Date: Mar. 27, 2015

(30) Foreign Application Priority Data
Sep. 27, 2012 (DE) 10 2012 018 995.8

(51) Int. Cl. C02F 1/36; C02F 1/32

(52) U.S. Cl. CPC C02F 1/36; C02F 1/32

(57) ABSTRACT

The invention relates to a method for treating a liquid, comprising the steps: introducing the liquid to be treated into a reaction chamber, subjecting the liquid to ultrasound, irradiating the liquid with UV radiation as the liquid is being subjected to ultrasound, and discharging the treated liquid from the reaction chamber. The method is characterized in that as the liquid is being subjected to ultrasound and is being irradiated with UV radiation, the liquid is simultaneously permeated by a gas.

The invention relates to a method for treating a liquid.

The invention relates in particular to a method for treating ballast water, water vapor, condensed water from air conditioning systems, for the treatment of potable water or for the treatment of waste water, e.g. toilet waste water.

A “device for treatment of liquids” is already known from DE 20 2004 020 459 U1, using which the proportion of undesirable fluid components, for example, germs, spores, herbicides, fungicides, pesticides, residual fertilizer, residual medications, toxins, and, in particular, endotoxins, can be reduced. This is achieved by the simultaneous impingement of an ultrasound and an ultraviolet source on the liquid to be treated.

Although the previously known method has already achieved good results, the object of the invention is to further improve the above-mentioned method with regard to its efficiency.

This object is achieved by the method having the features of claim 1. The dependent claims reflect advantageous embodiments of the invention.

The fundamental idea of the invention is to treat the liquid to be treated not only simultaneously with ultrasound and ultraviolet radiation, but to meanwhile allow the liquid to be flowed through by a gas. In this way, an advantageous interaction of gas bubbles, ultrasound, and ultraviolet radiation develops, using which an improved cleaning effect can be achieved.

The gas flowing through the liquid is preferably air.

Alternatively, the gas flowing through the liquid is an inert gas or a gas mixture including an inert gas.

Especially good treatment results can be achieved if the gas is present in the liquid as micro-dispersed gas bubbles. For this purpose, the gas of the liquid is preferably fed through a (close-meshed) sieve or through a ceramic element in order to also achieve a micro-dispersion of the gas as homogeneous as possible.

Here, the liquid and the gas are preferably guided into the reaction chamber in a parallel flow, wherein the liquid is especially preferably guided in a manner at least partially effecting a chaotic flow, for example by a flow deflector disposed on the inner wall of the reaction chamber.

In principle, however, it is also possible to guide liquid and gas in counter-flow or introduce the gas into the liquid transversely to the flow direction of the liquid.

1. A method for treating ballast water, vapor water, condensed water from air conditioning systems, potable water, or waste water for reducing the proportion of pesticides, herbicides, fungicides, fertilizers, medications, and toxins, including the steps:
introducing the ballast water, vapor water, condensed water, potable water, or waste water into a reaction chamber,
impinging on the ballast water, vapor water, condensed water, potable water, or waste water with ultrasound,
irradiating the ballast water, vapor water, condensed water, potable water, or waste water with ultraviolet radiation during the impingement of the liquid with ultrasound,
flowing through the ballast water, vapor water, condensed water, potable water, or waste water with a gas during the impingement with ultrasound and the irradiation with ultraviolet radiation, and
guiding the treated liquid out of the reaction chamber.

2. The method according to claim 1, characterized in that the gas is air.

3. The method according to claim 1, characterized in that the gas is an inert gas or a gas mixture including an inert gas.

4. A method according to claim 1, characterized in that the gas flows through the ballast water, vapor water, condensed water from air conditioning systems, potable water, or waste water as micro-dispersed gas bubbles.

5. A method according to claim 1, characterized in that the gas flows through the ballast water, vapor water, condensed water from air conditioning systems, potable water, or waste water in a parallel flow.

6. A method according to claim 1, characterized in that the ballast water, vapor water, condensed water from air conditioning systems, potable water, or waste water flows chaotically through the reaction chamber.

7. (canceled)

8. A method according to claim 2, characterized in that the gas flows through the ballast water, vapor water, condensed water from air conditioning systems, potable water, or waste water as micro-dispersed gas bubbles.

9. A method according to claim 3, characterized in that the gas flows through the ballast water, vapor water, condensed water from air conditioning systems, potable water, or waste water as micro-dispersed gas bubbles.

10. A method according to claim 2, characterized in that the gas flows through the ballast water, vapor water, condensed water from air conditioning systems, potable water, or waste water in a parallel flow.

11. A method according to claim 3, characterized in that the gas flows through the ballast water, vapor water, condensed water from air conditioning systems, potable water, or waste water in a parallel flow.

12. A method according to claim 4, characterized in that the gas flows through the ballast water, vapor water, condensed water from air conditioning systems, potable water, or waste water in a parallel flow.

13. A method according to claim 2, characterized in that the ballast water, vapor water, condensed water from air conditioning systems, potable water, or waste water flows chaotically through the reaction chamber.

14. A method according to claim 3, characterized in that the ballast water, vapor water, condensed water from air conditioning systems, potable water, or waste water flows chaotically through the reaction chamber.

15. A method according to claim 4, characterized in that the ballast water, vapor water, condensed water from air conditioning systems, potable water, or waste water flows chaotically through the reaction chamber.

16. A method according to claim 5, characterized in that the ballast water, vapor water, condensed water from air conditioning systems, potable water, or waste water flows chaotically through the reaction chamber.
